(19) United States
(12) Patent Application Publication
(10) Pub. No.: US 2026/0316671 A1
(43) Pub. Date: Oct. 15, 2026

(54) VEHICLE REAR LIGHTING SYSTEM AND METHOD OF CONTROLLING THE SAME

(71) Applicants: Hyundai Motor Company, Seoul (KR); Kia Corporation, Seoul (KR)

(72) Inventor: Sung Ho PARK, Hwaseong-Si (KR)

(21) Appl. No.: 19/326,246

(22) Filed: Sep. 11, 2025

(30) Foreign Application Priority Data
Apr. 10, 2025 (KR) 10-2025-0046948

(51) Int. Cl. B60Q 1/50; B60Q 1/22; B60Q 1/24; B60Q 1/46; B60Q 1/54

(52) U.S. Cl. CPC B60Q 1/5037; B60Q 1/22; B60Q 1/247; B60Q 1/46; B60Q 1/543; B60Q 1/54; B60Q 2400/50

(57) ABSTRACT

Provided is a vehicle rear lighting system. The vehicle rear lighting system may include: one or more image projectors configured to project one or more light patterns onto a ground around a rear gate of the vehicle; a diffused light projector configured to emit a diffused light pattern onto an illumination region of the ground around the rear gate; and a control circuit configured to control, based on signals received from one or more sensors of the vehicle, the one or more image projectors and the diffused light projector.

### CROSS-REFERENCE TO RELATED APPLICATION

This application claims the benefit of and priority to Korean Patent Application No. 10-2025-0046948, filed on Apr. 10, 2025, in the Korean Intellectual Property Office, the disclosure of which is incorporated herein in its entirety by reference.

### TECHNICAL FIELD

The present disclosure relates to vehicle safety systems, and more particularly to a vehicle rear lighting system and a method of controlling the same.

### BACKGROUND

A vehicle may include a lighting system that provides illumination to the ground near the vehicle. For example, the lighting system may include a road projection lamp projecting a symbol onto a road surface. The symbol may be projected, for example, to create a welcoming environment for passenger(s) or to ensure safety in front of the vehicle while driving.

In addition, the vehicle may include a backdoor provided on the rear thereof, and the backdoor may be any one of a trunk lid, a hatchback tailgate, a twin-swing tailgate, and a liftgate.

The backdoor may have a relatively large movement path and a complex opening/closing structure to secure sufficient rear space of the vehicle and improve accessibility to the rear space of the vehicle. This may increase the risk of collisions during the opening and closing of the backdoor, and make it difficult to secure night vision. In addition, when the vehicle is stopped and parked at night, there is a high risk of collisions with people, other vehicles, obstacles, and the like near the rear of the vehicle.

The vehicle rear lighting system in some implementations may fail to provide sufficient visual warning(s) about the opening/closing of the backdoor, the stopping/parking of the vehicle at night, and the like.

The above information described in this background section is provided to assist in understanding the background of the inventive concept, and may include any technical concept which is not considered prior art.

The present disclosure has been made to solve the above-mentioned problems occurring in at least some implementations while advantages achieved by those implementations are maintained intact.

An aspect of the present disclosure provides a vehicle rear lighting system designed to project various types of light patterns onto the ground to optically display vehicle information and backdoor information when a vehicle is stopped and parked at night.

According to one or more example embodiments of the present disclosure, a vehicle rear lighting system of a vehicle may include: one or more image projectors configured to project one or more light patterns onto a ground around a rear gate of the vehicle; a diffused light projector configured to emit a diffused light pattern onto an illumination region of the ground around the rear gate; and a control circuit configured to control, based on signals received from one or more sensors of the vehicle, the one or more image projectors and the diffused light projector.

The one or more light patterns may indicate at least a portion of a movement path of the rear gate. The illumination region may overlap with the movement path of the rear gate.

The control circuit may be further configured to: determine, based on dimensions of the rear gate, the movement path of the rear gate; and determine, based on the movement path of the rear gate, a position of the one or more light patterns and a size of the illumination region.

The one or more image projectors and the diffused light projector may be disposed at a rear portion of the vehicle.

Each of the one or more image projectors may include a gobo projector configured to project a respective light pattern, of the one or more light patterns, onto the ground around the rear gate of the vehicle.

The gobo projector may include: a light source configured to emit light; and an optical system configured to project the light emitted from the light source onto the ground around the rear gate. The optical system may include: a mask having one or more patterned openings corresponding to the one or more light patterns; and one or more lenses disposed behind the mask.

The diffused light projector may include: a light source configured to emit light; and a diffuser configured to diffuse the light emitted from the light source onto the ground around the rear gate.

The one or more sensors may be configured to: collect information about the vehicle; and generate, based on the information about the vehicle, the signals. The control circuit may be configured to control the one or more image projectors and the diffused light projector further based on information about the rear gate.

According to one or more example embodiments of the present disclosure, a method performed by an apparatus of a vehicle may include: determining, based on dimensions of a rear gate of the vehicle, a movement path of the rear gate; determining, based on the movement path of the rear gate, a position of one or more light patterns and a size of an illumination region; and, based on a speed of the vehicle being decreased and the vehicle performing a reversing operation: projecting, in a first color via one or more image projectors of the vehicle, at least one light pattern, of the one or more light patterns, that indicates the reversing operation of the vehicle; and projecting, in the first color via a diffused light projector of the vehicle, diffused light onto the illumination region.

The method may further include, based on an angle change of a steering wheel of the vehicle: projecting, in the first color via the one or more image projectors, at least one light pattern, of the one or more light patterns, that indicates a reversing direction of the vehicle; and projecting, in the first color via the diffused light projector, the diffused light onto the illumination region.

The method may further include, based on detecting an object or a pedestrian around a rear of the vehicle: projecting, in a second color via the one or more image projectors, at least one light pattern, of the one or more light patterns, that indicates a reversing direction of the vehicle; and projecting, in the second color via the diffused light projector, the diffused light onto the illumination region.

The method may further include, based on the vehicle being stopped, projecting, in the first color via the one or more image projectors, the one or more light patterns.

The method may further include, based on a vehicle occupant exiting the vehicle, projecting, in the first color via the diffused light projector, the diffused light onto the illumination region.

The method may further include, based on detecting a vehicle occupant being within a threshold distance from a rear of the vehicle: projecting and blinking, in a second color via the one or more image projectors, the one or more light patterns; and projecting and blinking, in the second color via the diffused light projector, the illumination region.

The method may further include, based on detecting a person approaching a rear of the vehicle: projecting and blinking, in a second color via the one or more image projectors, the one or more light patterns; and projecting and blinking, in the second color via the diffused light projector, the illumination region.

According to one or more example embodiments of the present disclosure, an apparatus for a vehicle may include: a projector configured to emit one or more light patterns on a ground surface; and a control circuit configured to control, based on determining that a rear gate of the vehicle is open, the projector to emit the one or more light patterns on the ground surface. The one or more light patterns may indicate, on the ground surface, a clearance area of the rear gate.

The projector may include at least one of a gobo projector or a diffused light projector.

The control circuit may be further configured to control, based on determining that a person is approaching the vehicle, the projector to emit and blink the one or more light patterns on the ground surface.

Each of the one or more light patterns may include a line segment indicating a border of the clearance area.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example vehicle rear lighting system disposed below a backdoor of a vehicle;

FIG. 2 illustrates a perspective view of an example vehicle rear lighting system disposed on a rear bumper of a vehicle;

FIG. 3 illustrates a perspective view of an example vehicle rear lighting system with a protection cover removed from a housing;

FIG. 4 illustrates a perspective view of an example vehicle rear lighting system with a protection cover mounted on a housing;

FIG. 5 illustrates a schematic view of a plurality of images and an illuminated region projected onto the ground by an example vehicle rear lighting system;

FIG. 6 illustrates an example vehicle rear lighting system disposed below a backdoor of a vehicle;

FIG. 7 illustrates a schematic view of a plurality of images and illuminated regions projected onto the ground by an example vehicle rear lighting system;

FIG. 8 illustrates an example of an projector in an example vehicle rear lighting system;

FIG. 9 illustrates a diffused light projection unit in an example vehicle rear lighting system;

FIG. 10 illustrates a configuration of an example vehicle information system, a controller, an image light projection unit, and a diffused light projection unit in an example vehicle rear lighting system;

FIG. 11 illustrates a flowchart of an example method of controlling a vehicle rear lighting system;

FIG. 12 illustrates the determination of display positions of a plurality of images and a range (e.g., size) of an illuminated region based on backdoor information in an example vehicle rear lighting system;

FIG. 13 illustrates at least one of a plurality of images projected in a first color and an illuminated region projected in a first color by an example vehicle rear lighting system if a vehicle is moving backwards;

FIG. 14 illustrates at least one of a plurality of images projected in a first color to indicate a vehicle’s reverse direction by an example vehicle rear lighting system;

FIG. 15 illustrates at least one of a plurality of images projected in a second color and an illuminated region projected in a second color by an example vehicle rear lighting system if there is a pedestrian around the rear of a vehicle;

FIG. 16 illustrates a plurality of images projected in a first color by an example vehicle rear lighting system if a vehicle is stopped;

FIG. 17 illustrates an illuminated region projected in a first color if an occupant exits a vehicle while a plurality of images are projected in a first color by an example vehicle rear lighting system;

FIG. 18 illustrates a plurality of images and an illuminated region projected in a first color by an example vehicle rear lighting system if an occupant is located near the rear of a vehicle;

FIG. 19 illustrates a plurality of images and an illuminated region projected and blinked in a second color by an example vehicle rear lighting system if an occupant is located away from the rear of a vehicle (e.g., at least a threshold distance away from the rear of the vehicle) while a backdoor is opened or if a suspicious person is approaching the rear of the vehicle;

FIG. 20 illustrates the determination of display positions of a plurality of images and ranges of illuminated regions based on backdoor information in an example vehicle rear lighting system;

FIG. 21 illustrates at least one of a plurality of images projected in a first color and illuminated regions projected in a first color by an example vehicle rear lighting system if a vehicle is moving backwards (or reversing);

FIG. 22 illustrates at least one of a plurality of images projected in a first color to indicate a vehicle’s reverse direction by an example vehicle rear lighting system;

FIG. 23 illustrates at least one of a plurality of images projected in a second color and illuminated regions projected in a second color by an example vehicle rear lighting system if there is a pedestrian around the rear of a vehicle;

FIG. 24 illustrates a plurality of images projected in a first color by an example vehicle rear lighting system if a vehicle is stopped;

FIG. 25 illustrates illuminated regions projected in a first color when an occupant exits a vehicle in a state in which a plurality of images are projected in a first color by an example vehicle rear lighting system;

FIG. 26 illustrates a plurality of images and illuminated regions projected in a first color by an example vehicle rear lighting system if an occupant is located near (e.g., within a threshold distance from) the rear of a vehicle;

FIG. 27 illustrates a plurality of images and illuminated regions projected and blinked in a second color by an example vehicle rear lighting system if an occupant is located away from the rear of a vehicle in a state in which a backdoor is opened or if a suspicious person is approaching the rear of the vehicle;

FIG. 28 shows an example computing system.

### DETAILED DESCRIPTION

Hereinafter, one or more example embodiments of the present disclosure will be described in detail with reference to the accompanying drawings. In the drawings, the same reference numerals will be used throughout to designate the same or equivalent elements. In addition, a detailed description of well-known techniques associated with the present disclosure may be omitted in order not to unnecessarily obscure the gist of the present disclosure.

Terms such as first, second, A, B, (a), and (b) may be used to describe the elements in example embodiment(s) of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., receiving information about a rear gate of the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., receiving information about a rear gate of the vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., receiving information about a rear gate of the vehicle) described herein.

Minimum risk maneuver (MRM) operation(s) may also be controlled, for example, based on one or more features (e.g., receiving information about a rear gate of the vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., receiving information about a rear gate of the vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., receiving information about a rear gate of the vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., receiving information about a rear gate of the vehicle) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). The operation control may be for example, projecting light patterns and/or images, for example, to prevent collisions with another object or injuring a passenger or pedestrian.

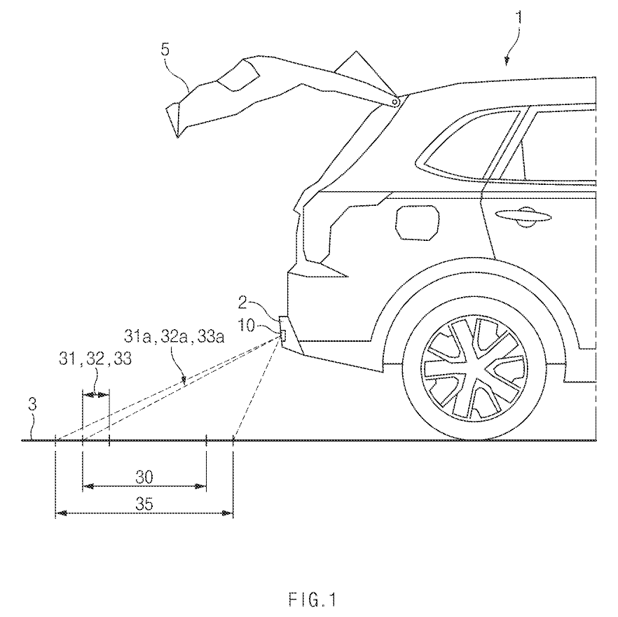

FIG. 1 illustrates an example vehicle rear lighting system disposed below a backdoor of a vehicle. A vehicle 1 may include a backdoor 5 or 7, and a rear bumper 2 disposed below the backdoor 5 or 7. A backdoor may also be referred to as a rear gate, and it may be, for example, a tailgate, a liftgate, a hatch, a trunk, a door, etc.

The backdoor 5 may be a hatchback tailgate mounted on a top end of the rear of the vehicle 1 in a swingable manner. Specifically, the backdoor 5 may be a hatchback tailgate 5 designed to swing upward to provide access to a rear space of the vehicle 1. If the backdoor 5 is opened (e.g., based on detecting an opening operation of the backdoor 5), a movement path 30 of the backdoor 5 may be virtually projected onto the ground 3 adjacent to the backdoor 5. The movement path 30 may be an area where the backdoor 5 travels as it opens or closes, and the movement path 30 may also be referred to as an opening arc, a swing path, a clearance area of the backdoor 5. A vehicle rear lighting system 10 may be disposed adjacent to a lower rear portion of the vehicle 1, and be designed to optically display the movement path 30 of the backdoor 5 virtually projected onto the ground 3 adjacent to the backdoor 5.

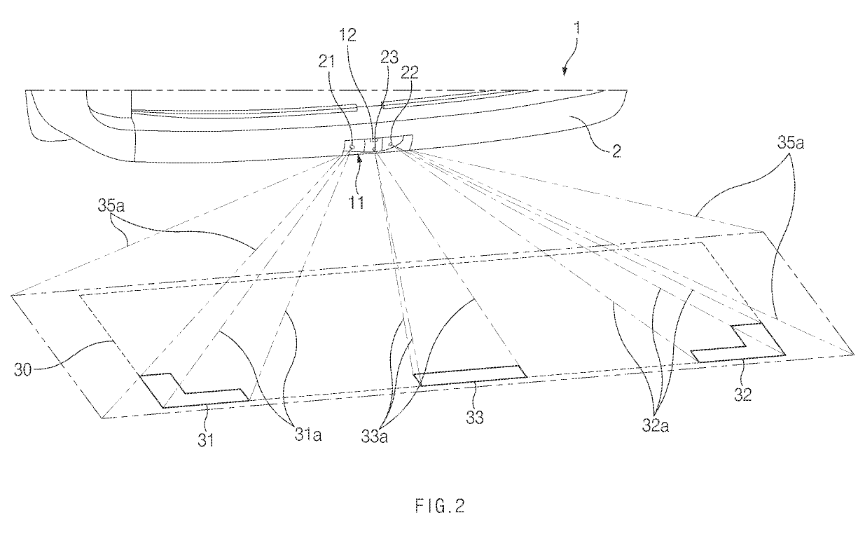

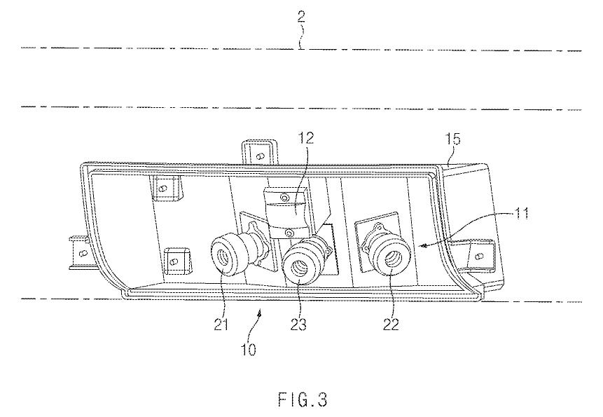

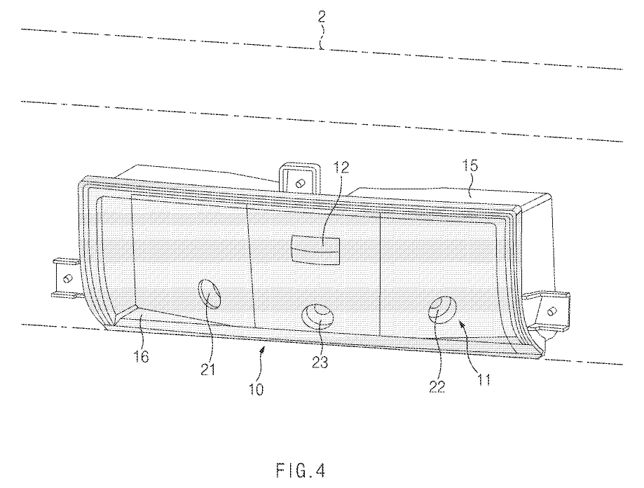

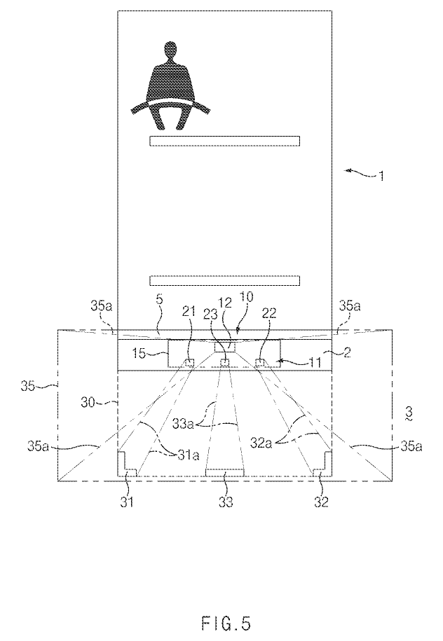

FIGS. 1 to 5 illustrate the vehicle rear lighting system 10, which is applied to the vehicle 1 having the hatchback tailgate 5. FIG. 2 illustrates a perspective view of an example vehicle rear lighting system disposed on a rear bumper of a vehicle. FIG. 3 illustrates a perspective view of an example vehicle rear lighting system with a protection cover removed from a housing. FIG. 4 illustrates a perspective view of an example vehicle rear lighting system with a protection cover mounted on a housing. FIG. 5 illustrates a schematic view of a plurality of images and an illuminated region projected onto the ground by an example vehicle rear lighting system.

Referring to FIG. 2, the vehicle rear lighting system 10 may be disposed on the rear bumper 2 of the vehicle 1. The vehicle rear lighting system 10 may project the following light pattern(s) onto the ground 3 adjacent to the backdoor 5: a plurality of light patterns 31a, 32a, and 33a displaying a plurality of images (image light) 31, 32, and 33, respectively; and a diffused light pattern 35a defining (e.g., demarcating, delineating, etc.) a predetermined illuminated region (also referred to as an illumination region) 35 including the movement path 30 of the backdoor 5 projected onto the ground 3. The light pattern may be expressed in any desired color or colors and be represented by light rays projected from each projector of the vehicle rear lighting system. The plurality of images 31, 32, and 33 may define at least a portion of the movement path 30 of the backdoor 5 virtually projected onto the ground 3 adjacent to the backdoor 5, and the illuminated region 35 may include (e.g., overlap with) the movement path 30 of the backdoor 5. The plurality of images 31, 32, and 33 may include, for example, one or more line segments (e.g., straight line segments, angled line segments, etc.). Each of the one or more line segments may indicate, for example, a border of the illuminated region 35.

Referring to FIGS. 3 and 5, the vehicle rear lighting system 10 may include a housing 15 mounted on a middle portion of the rear bumper 2 of the vehicle 1, and an image light projection unit (also referred to as a light projector, an image projector, a lamp, etc.) 11 and a diffused light projection unit (also referred to as a light diffuser, a diffused light projector, etc.) 12 disposed in the housing 15.

The image light projection unit 11 may include a plurality of image light projectors 21, 22, and 23 projecting the plurality of light patterns 31a, 32a, and 33a onto the ground 3 to display the plurality of images 31, 32, and 33, respectively, each image defining at least a portion of the movement path 30 of the backdoor 5 projected onto the ground 3 adjacent to the backdoor 5. Each of the images 31, 32, and 33 may be expressed in different shapes such as, but not limited to, a dot shape or a line shape. An image light projector (also referred to as an image projector) may be, for example, a gobo projector or a structured light projector.

The plurality of image light projectors 21, 22, and 23 may include a first image light projector 21 projecting a first light pattern 31a onto the ground 3 to display a first image 31, a second image light projector 22 projecting a second light pattern 32a onto the ground 3 to display a second image 32, and a third image light projector 23 projecting a third light pattern 33a onto the ground 3 to display a third image 33. The first image 31 may define a left end of the movement path 30 of the backdoor 5, the second image 32 may define a right end of the movement path 30 of the backdoor 5, and the third image 33 may define a middle portion of the movement path 30 of the backdoor 5.

Referring to FIGS. 2 and 5, the diffused light projection unit 12 may project (e.g., emit) the diffused light pattern 35a onto the ground 3 to display the predetermined illuminated region 35 including the movement path 30 of the backdoor 5. Referring to FIG. 3, the diffused light projection unit 12 may be located above the image light projection unit 11.

Referring to FIG. 4, the vehicle rear lighting system 10 may include a protection cover 16 mounted on the housing 15, and the protection cover 16 may protect the image light projection unit 11 and the diffused light projection unit 12. The protection cover 16 may be formed of a transparent material allowing the light projected from the image light projection unit 11 and the diffused light projection unit 12 to transmit therethrough.

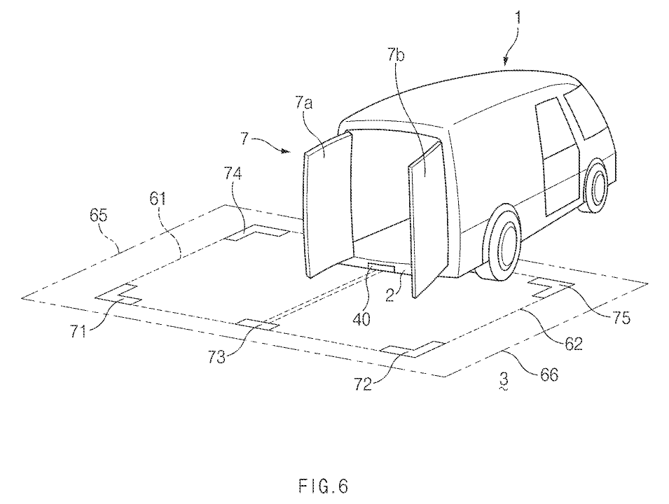

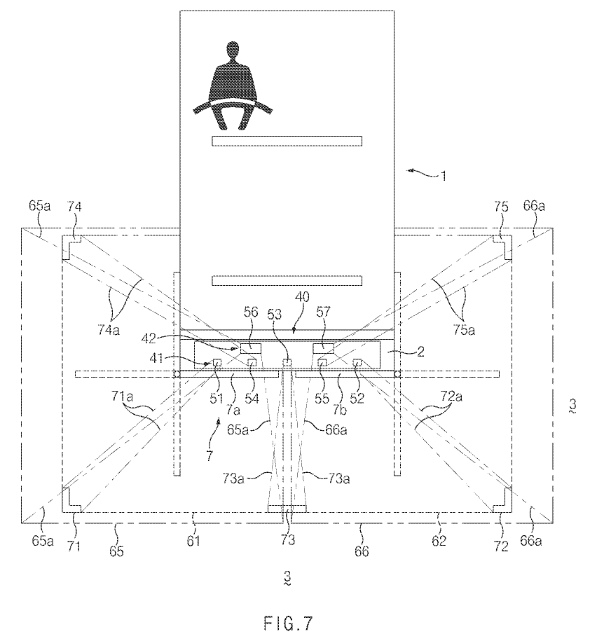

FIG. 6 illustrates an example vehicle rear lighting system disposed below a backdoor of a vehicle. FIG. 7 illustrates a schematic view of a plurality of images and illuminated regions projected onto the ground by an example vehicle rear lighting system. A vehicle rear lighting system 40 may be applied to a vehicle having a twin door tailgate.

Referring to FIG. 6, the backdoor 7 may be a twin door tailgate including a pair of swing doors 7a and 7b designed to open and close sideways at the rear of the vehicle 1. A first swing door 7a and a second swing door 7b may swing on rear ends of both sides of the vehicle 1. If the first swing door 7a is opened, a first movement path 61 of the first swing door 7a may be virtually projected onto the ground 3 adjacent to the first swing door 7a, and if the second swing door 7b is opened, a second movement path 62 of the second swing door 7b may be virtually projected onto the ground 3 adjacent to the second swing door 7b. The vehicle rear lighting system 40 may be disposed adjacent to a lower rear portion of the vehicle 1, and be designed to optically display the movement paths 61 and 62 of the backdoor 7 virtually projected onto the ground 3 adjacent to the backdoor 7.

The vehicle rear lighting system 40 may be disposed adjacent to the lower rear portion of the vehicle 1 adjacent to the backdoor 7. Referring to FIG. 7, the vehicle rear lighting system 40 may be disposed on the rear bumper 2 of the vehicle 1. The vehicle rear lighting system 40 may project the following light pattern(s) onto the ground 3 adjacent to the backdoor 7: a plurality of light patterns 71a, 72a, 73a, 74a, and 75a defining a plurality of images (image light) 71, 72, 73, 74, and 75, respectively; and diffused light patterns 65a and 66a defining illuminated regions 65 and 66, respectively. The light pattern may be expressed in any desired color or colors and be represented by light rays projected from each projector of the vehicle rear lighting system. The plurality of images 71, 72, 73, 74, and 75 may define at least a portion of the first movement path 61 and the second movement path 62 of the backdoor 7 virtually projected onto the ground 3 adjacent to the backdoor 7. A first illuminated region 65 may include the first movement path 61, and a second illuminated region 66 may include the second movement path 62.

Referring to FIG. 7, the vehicle rear lighting system 40 may include an image light projection unit 41 and a diffused light projection unit 42 disposed on a middle portion of the rear bumper 2 of the vehicle 1.

The image light projection unit 41 may include a plurality of image light projectors 51, 52, 53, 54, and 55 projecting the plurality of light patterns 71a, 72a, 73a, 74a, and 75a onto the ground 3 to display the plurality of images 71, 72, 73, 74, and 75, respectively, each image defining at least a portion of the movement paths 61 and 62 of the backdoor 7 projected onto the ground 3 adjacent to the backdoor 7. Each of the images 71, 72, 73, 74, and 75 may be expressed in different shapes such as, but not limited to, a dot shape or a line shape.

The plurality of image light projectors 51, 52, 53, 54, and 55 may include a first image light projector 51 projecting a first light pattern 71a onto the ground 3 to display a first image 71, a second image light projector 52 projecting a second light pattern 72a onto the ground 3 to display a second image 72, a third image light projector 53 projecting a third light pattern 73a onto the ground 3 to display a third image 73, a fourth image light projector 54 projecting a fourth light pattern 74a onto the ground 3 to display a fourth image 74, and a fifth image light projector 55 projecting a fifth light pattern 75a onto the ground 3 to display a fifth image 75. The first image 71 may define a left rear end of the first movement path 61 of the first swing door 7a, the second image 72 may define a right rear end of the second movement path 62 of the second swing door 7b, the third image 73 may define a right rear end of the first movement path 61 of the first swing door 7a and a left rear end of the second movement path 62 of the second swing door 7b together, the fourth image 74 may define a left front end of the first movement path 61 of the first swing door 7a, and the fifth image 75 may define a right front end of the second movement path 62 of the second swing door 7b.

Referring to FIG. 7, the diffused light projection unit 42 may project the plurality of diffused light patterns 65a and 66a onto the ground 3 to display the predetermined illuminated regions 65 and 66 including the movement paths 61 and 62 of the backdoor 7. The diffused light projection unit 42 may be located above the image light projection unit 41. The diffused light projection unit 42 may include a first diffused light projector 56 projecting a first diffused light pattern 65a onto the ground 3 to display the first illuminated region 65 including the first movement path 61 of the backdoor 7, and a second diffused light projector 57 projecting a second diffused light pattern 66a onto the ground 3 to display the second illuminated region 66 including the second movement path 62 of the backdoor 7.

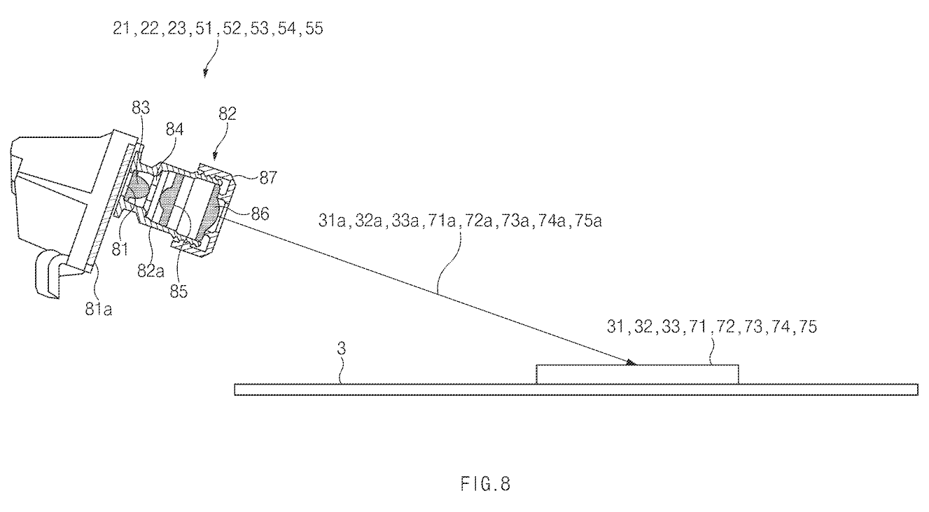

FIG. 8 illustrates an example of each of the image light projectors 21, 22, 23, 51, 52, 53, 54, and 55.

Referring to FIG. 8, each of the image light projectors (e.g., gobo projectors) 21, 22, 23, 51, 52, 53, 54, and 55 may include a light source 81, and an optical system 82 projecting light emitted from the light source 81 onto the ground 3. The light source 81 may be an LED mounted on a PCB 81a, and the light source 81 may emit light of various colors. The optical system 82 may include a barrel 82a connected to the light source 81, a collimator 83 disposed in the barrel 82a, a mask (e.g., gobo) 84 disposed behind the collimator 83, and a plurality of lenses 85 and 86 disposed behind the mask 84. The barrel 82a may have an opening provided at both ends thereof. One end of the barrel 82a may face the light source 81, and the other end of the barrel 82a may face the ground 3. The light source 81 may be disposed in the opening of one end of the barrel 82a, and an optical cap 87 may be mounted at the other end of the barrel 82a. The collimator 83 may make the light rays emitted from the light source 81 parallel. The mask 84 may have patterned openings, and the mask 84 may determine a respective one of the light patterns 31a, 32a, 33a, 71a, 72a, 73a, 74a, and 75a through the patterned openings so as to display a respective one of the images 31, 32, 33, 71, 72, 73, 74, and 75. That is, the shape, size, and the like of each of the images 31, 32, 33, 71, 72, 73, 74, and 75 may be determined by the patterned openings of the mask 84. The plurality of lenses 85 and 86 may be configured to allow the light rays passing through the mask 84 to form an image onto the ground 3.

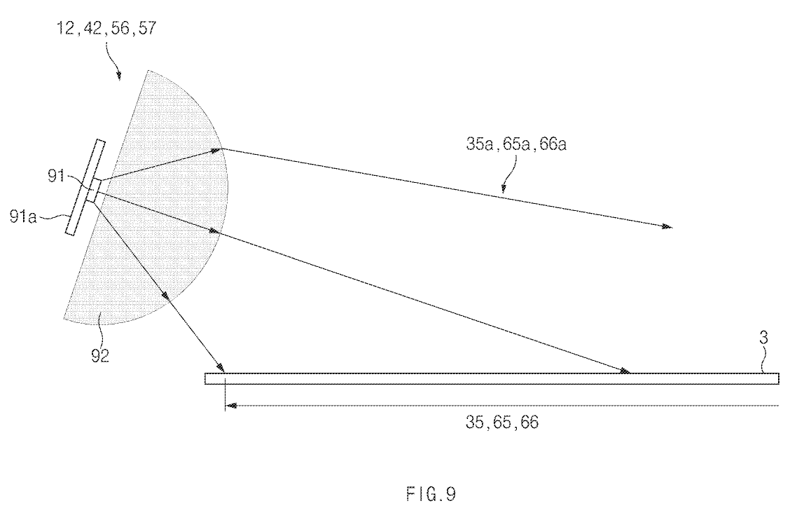

FIG. 9 illustrates an example of each of the diffused light projection units 12 and 42.

Referring to FIG. 9, the diffused light projection unit 12 illustrated in FIGS. 1 to 5 and each of the diffused light projectors 56 and 57 in the diffused light projection unit 42 illustrated in FIGS. 6 and 7 may include a light source 91, and a diffuser 92 allowing light emitted from the light source 91 to spread out to the ground 3. The light source 91 may be an LED mounted on a PCB 91a, and the light source 91 may emit light of various colors. The diffuser 92 may determine a respective one of the diffused light patterns 35a, 65a, and 66a to define a respective one of the illuminated regions 35, 65, and 66. That is, the range of each of the illuminated regions 35, 65, and 66 may be determined by the shape and size of the diffuser 92.

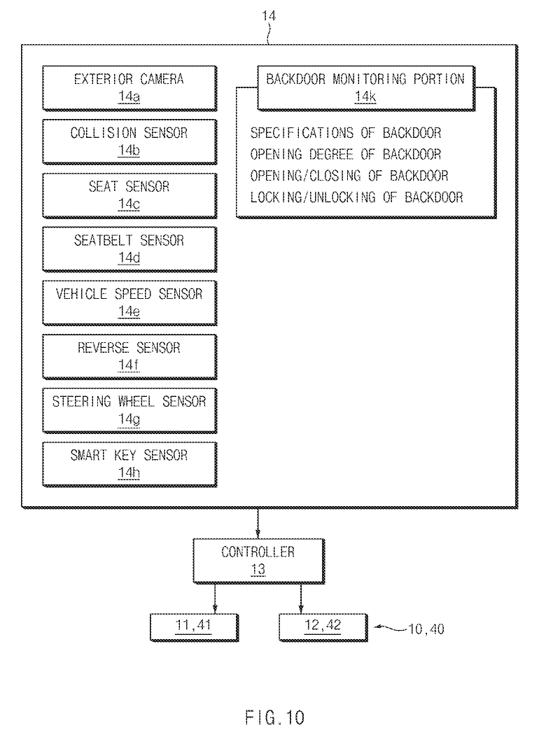

Referring to FIG. 10, the vehicle rear lighting system 10 or 40 may include a controller (also referred to as a control circuit) 13 controlling the image light projection unit 11 or 41 and the diffused light projection unit 12 or 42 based on information of the vehicle and information of the backdoor obtained from a vehicle information system 14.

The vehicle information system 14 may include one or more sensors, such as sensors 14a, 14b, 14c, 14d, 14e, 14f, 14g, and 14h sensing the vehicle information, and a backdoor monitoring portion 14k monitoring the backdoor information. The plurality of sensors 14a, 14b, 14c, 14d, 14e, 14f, 14g, and 14h may include an exterior camera 14a recognizing the presence of objects (e.g., obstacles or other vehicles) and/or pedestrians near or around the vehicle 1, a collision sensor 14b sensing a collision of the vehicle, a seat sensor 14c detecting whether an occupant is seated, a seatbelt sensor 14d detecting whether a seatbelt is fastened, a vehicle speed sensor 14e sensing a speed of the vehicle, a reverse sensor 14f detecting whether the vehicle is moving backwards (reversing), a steering wheel sensor 14g sensing an angle of a steering wheel, and a smart key sensor 14h detecting whether a smart key is locked or unlocked. The one or more sensors 14a, 14b, 14c, 14d, 14e, 14f, 14g, and/or 14h may generate one or more signals (e.g., electric signals) that indicate information about the vehicle and/or the backdoor, and send the signals to the controller 13. The backdoor monitoring portion 14k may monitor the backdoor information (e.g., track the status of the backdoor) such as the specifications (dimensions, structure, shape, size, etc.) of the backdoor, the opening degree of the backdoor, the movement path of the backdoor, the opening/closing of the backdoor, and the locking/unlocking of the backdoor. The vehicle information system 14 may be configured to transmit the vehicle information to the controller 13 through the plurality of sensors 14a, 14b, 14c, 14d, 14e, 14f, 14g, and 14h, and the vehicle information may include the following information: whether the vehicle is reversing; whether the vehicle is stopped; whether an occupant exits the vehicle; whether there is an object (obstacles, other vehicles, etc.) and/or a pedestrian around the vehicle; and whether a suspicious person is approaching.

The controller 13 may calculate the movement path 30 or movement paths 61 and 62 of the backdoor 5 or 7 projected onto the ground 3 based on the specifications (dimensions, structure, shape, size, etc.) of the backdoor obtained from the backdoor monitoring portion 14k, and determine display positions of the plurality of images 31, 32, and 33 or images 71, 72, 73, 74, and 75 and a range of the illuminated region 35 or ranges of the illuminated regions 65 and 66 based on the calculated movement path 30 or movement paths 61 and 62 of the backdoor 5 or 7.

The controller 13 may control the operations of the image light projection unit 11 or 41 and the diffused light projection unit 12 or 42 in a manner that allows at least one of the plurality of light patterns 31a, 32a, and 33a or light patterns 71a, 72a, 73a, 74a, and 75a and the diffused light pattern 35a or light patterns 65a and 66a to be projected onto the ground 3 based on the following information: whether the vehicle is reversing; whether the vehicle is stopped; whether an occupant exits the vehicle; whether there is an object (obstacles, other vehicles, etc.) and/or a pedestrian around the vehicle; whether the backdoor is opened; and whether a suspicious person is approaching, and thus at least one of the plurality of images 31, 32, and 33 or images 71, 72, 73, 74, and 75 and the illuminated region 35 or illuminated regions 65 and 66 may be projected in various colors on the ground 3. The image light projection unit 11 or 41 may project a light pattern of a first color onto the ground 3 so that an image illuminated in the first color (i.e., image light of the first color) may be projected on the ground 3, and the image light projection unit 11 or 41 may project a light pattern of a second color onto the ground 3 so that an image illuminated in the second color (i.e., image light of the second color) may be projected on the ground 3. The diffused light projection unit 12 or 42 may project a diffused light pattern of the first color onto the ground 3 so that an illuminated region of the first color may be projected on the ground 3, and the diffused light projection unit 12 or 42 may project a diffused light pattern of the second color onto the ground 3 so that an illuminated region of the second color may be projected on the ground 3.

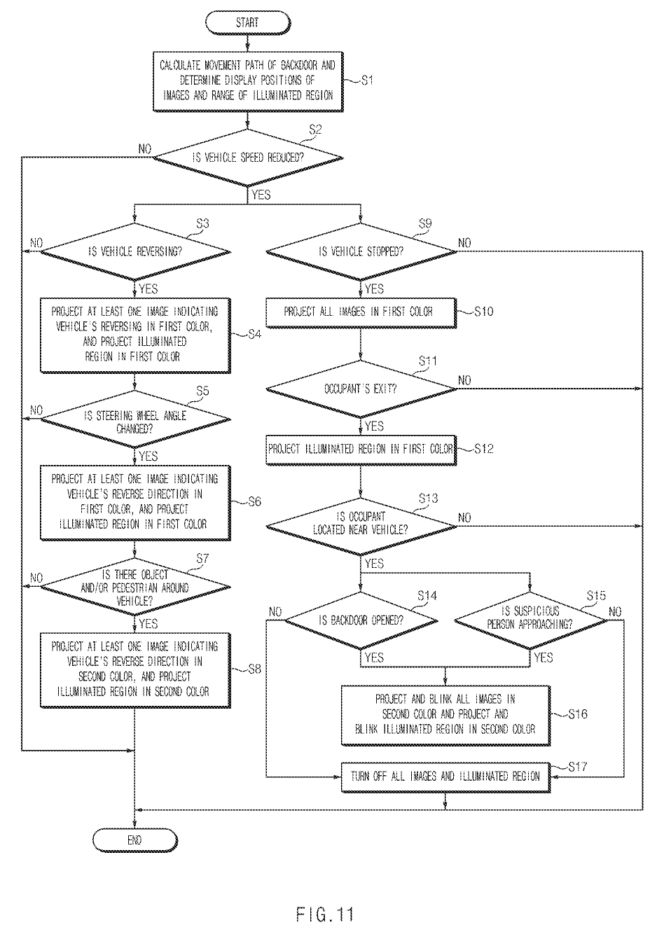

FIG. 11 illustrates a flowchart of a method of controlling the vehicle rear lighting system 10 or 40.

Referring to FIG. 11, the controller 13 may calculate the movement path 30 or movement paths 61 and 62 of the backdoor 5 or 7 based on the specifications (dimensions, structure, shape, size, etc.) of the backdoor 5 or 7 monitored by the backdoor monitoring portion 14k, and determine display positions of the plurality of images 31, 32, and 33 or images 71, 72, 73, 74, and 75 and a range (e.g., size) of the illuminated region 35 or ranges of the illuminated regions 65 and 66 based on the calculated movement path 30 or movement paths 61 and 62 of the backdoor 5 or 7 (S1).

The controller 13 may determine, by the vehicle speed sensor 14e, whether the vehicle speed is reduced (decelerated) (S2).

If it is determined in S2 that the vehicle speed has been reduced, the controller 13 may determine, by the reverse sensor 14f, whether the vehicle 1 is moving backwards (S3).

If it is determined in S3 that the vehicle 1 is moving backwards (reversing), the controller 13 may control the operation of the image light projection unit 11 or 41 to project at least one of the plurality of images 31, 32, and 33 or images 71, 72, 73, 74, and 75 indicating the reversing of the vehicle 1 in a first color (e.g., white), and control the operation of the diffused light projection unit 12 or 42 to project the illuminated region 35 or illuminated regions 65 and 66 in the first color (e.g., white) (S4).

If the vehicle 1 is moving backwards, the controller 13 may determine, by the steering wheel sensor 14g, whether an angle of a steering wheel is changed (S5).

If it is determined by the steering wheel sensor 14g in S5 that the angle of the steering wheel is changed, a vehicle’s reverse direction may be determined as the angle of the steering wheel is changed, and the controller 13 may control the operation of the image light projection unit 11 or 41 to project at least one of the plurality of images 31, 32, and 33 or images 71, 72, 73, 74, and 75 indicating the vehicle’s reverse direction in the first color, and control the operation of the diffused light projection unit 12 or 42 to project the illuminated region 35 or illuminated regions 65 and 66 in the first color (S6).

The controller 13 may determine, by the exterior camera 14a, whether there is an object and/or a pedestrian around the rear of the vehicle 1 (S7).

If it is determined in S7 that there is an object and/or a pedestrian around the rear of the vehicle 1, the controller 13 may control the operation of the image light projection unit 11 or 41 to project at least one of the plurality of images 31, 32, and 33 or images 71, 72, 73, 74, and 75 indicating the vehicle’s reverse direction in a second color (e.g., red), and control the operation of the diffused light projection unit 12 or 42 to project the illuminated region 35 or illuminated regions 65 and 66 in the second color (e.g., red) (S8).

If it is determined in S2 that the vehicle speed has been reduced, the controller 13 may determine, by the vehicle speed sensor 14e, whether the vehicle 1 is stopped (S9).

If it is determined in S9 that the vehicle 1 is stopped, the controller 13 may control the operation of the image light projection unit 11 or 41 to project all of the plurality of images 31, 32, and 33 or images 71, 72, 73, 74, and 75 in the first color (e.g., white) (S10).

The controller 13 may determine, by the seat sensor 14c and the seatbelt sensor 14d, whether an occupant exits the vehicle 1 (S11).

If it is determined in S11 that the occupant has exited the vehicle 1, the controller 13 may control the operation of the diffused light projection unit 12 or 42 to project the illuminated region 35 or illuminated regions 65 and 66 in the first color (e.g., white) (S12) in a state in which all of the plurality of images 31, 32, and 33 or images 71, 72, 73, 74, and 75 are projected in the first color (e.g., white) by the image light projection unit 11 or 41.

The controller 13 may determine, by the exterior camera 14a, whether the occupant is located near the rear of the vehicle 1 (S13).

If it is determined in S13 that the occupant is located near the rear of the vehicle 1, the controller 13 may determine, by the backdoor monitoring portion 14k, whether the backdoor 5 or 7 is opened (S14).

If it is determined in S14 that the backdoor 5 or 7 is opened, the controller 13 may control the operation of the image light projection unit 11 or 41 to project and blink all of the plurality of images 31, 32, and 33 or images 71, 72, 73, 74, and 75 (i.e., each image light repeatedly turns on and off at regular intervals) in the second color (e.g., red), and control the operation of the diffused light projection unit 12 or 42 to project and blink the illuminated region 35 or illuminated regions 65 and 66 (i.e., each illuminated region repeatedly turns on and off at regular intervals) in the second color (e.g., red) (S16).

If it is determined in S14 that the backdoor 5 or 7 is not opened, the controller 13 may control the operations of the image light projection unit 11 or 41 and the diffused light projection unit 12 or 42 to turn off the plurality of images 31, 32, and 33 or images 71, 72, 73, 74, and 75 and the illuminated region 35 or illuminated regions 65 and 66 (S17).

If it is determined in S13 that the occupant is located near the rear of the vehicle 1, the controller 13 may determine, by the exterior camera 14a, whether a suspicious person is approaching the rear of the vehicle 1 (S15).

If it is determined in S15 that the suspicious person is approaching the rear of the vehicle 1, the controller 13 may control the operation of the image light projection unit 11 or 41 to project and blink the plurality of images 31, 32, and 33 or images 71, 72, 73, 74, and 75 in the second color (e.g., red), and control the operation of the diffused light projection unit 12 or 42 to project and blink the illuminated region 35 or illuminated regions 65 and 66 in the second color (e.g., red) (S16).

If it is determined in S15 that any suspicious person is not approaching the rear of the vehicle 1, the controller 13 may control the operations of the image light projection unit 11 or 41 and the diffused light projection unit 12 or 42 to turn off the plurality of images 31, 32, and 33 or images 71, 72, 73, 74, and 75 and the illuminated region 35 or illuminated regions 65 and 66 (S17).

The first color may be used to provide guides indicating the reversing of the vehicle 1, the vehicle’s reverse direction, the stopping of the vehicle 1, the occupant exiting the vehicle, and the occupant being near the rear of the vehicle 1, and the second color may be used to provide warnings indicating the opening of the backdoor 5 or 7, the presence of an object and/or a pedestrian being around the rear of the vehicle 1, and the approach of a suspicious person.

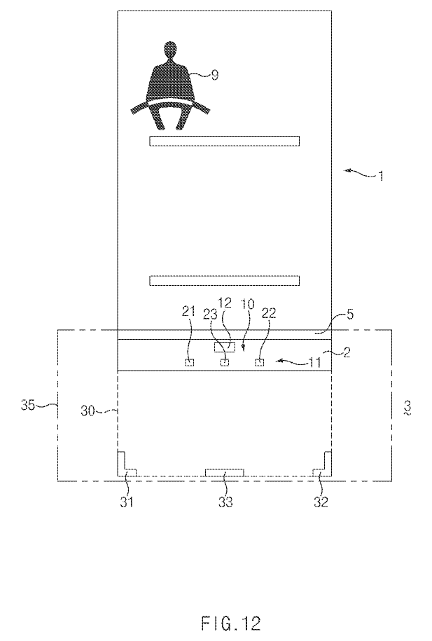

FIGS. 12 to 19 illustrate a control operation of the vehicle rear lighting system 10 illustrated in FIGS. 1 to 5.

Referring to FIG. 12, the controller 13 may check the specifications (dimensions, structure, size, shape, etc.) of the backdoor 5 by the backdoor monitoring portion 14k, and confirm that the backdoor 5 is a hatchback tailgate. The controller 13 may calculate the movement path 30 of the backdoor 5 based on the information of the backdoor 5, and determine the display positions of the plurality of images 31, 32, and 33 and the range of the illuminated region 35 based on the calculated movement path 30 of the backdoor 5.

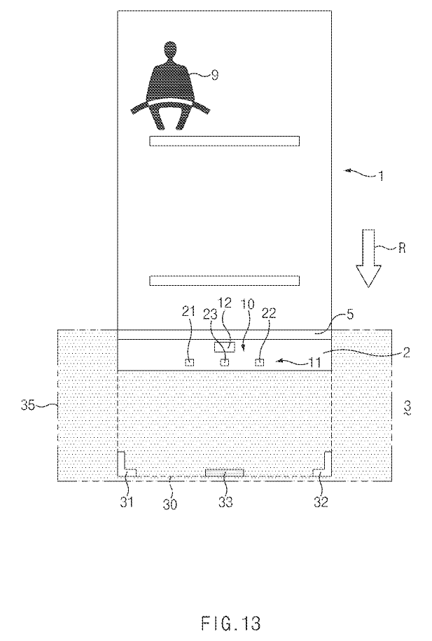

Referring to FIG. 13, if the vehicle 1 is moving backwards or reversing (see direction indicated by arrow R) for parking, the third image 33 among the plurality of images 31, 32, and 33 may be projected in the first color by the image light projection unit 11, and the illuminated region 35 may be projected in the first color by the diffused light projection unit 12.

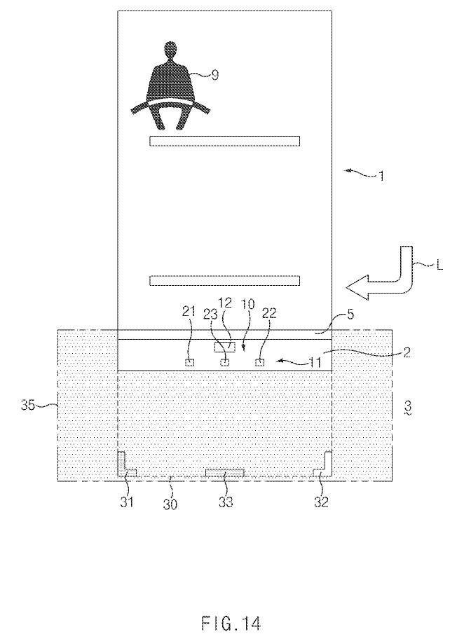

Referring to FIG. 14, as the vehicle 1 is moving backwards or reversing, some images 31 and 33 among the plurality of images 31, 32, and 33 may be projected in the first color by the image light projection unit 11 to indicate the vehicle’s reverse direction. As shown in FIG. 14, if the vehicle 1 is moving backwards to the left (see direction indicated by arrow L), the first image 31 and the third image 33 may be projected in the first color, and the illuminated region 35 may be projected in the first color. Although not shown, if the vehicle 1 is moving backwards to the right, the second image 32 and the third image 33 may be projected in the first color, and the illuminated region 35 may be projected in the first color.

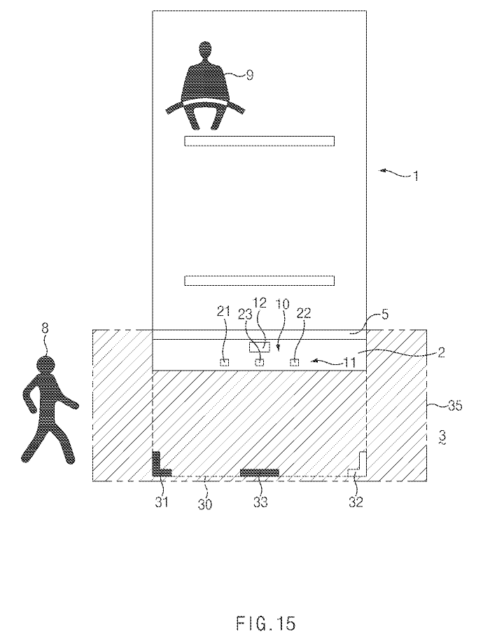

Referring to FIG. 15, if there is an object and/or a pedestrian 8 around the rear of the vehicle 1, some images (for example, the first image 31 and the third image 33) may be projected in the second color by the image light projection unit 11, and the illuminated region 35 may be projected in the second color by the diffused light projection unit 12.

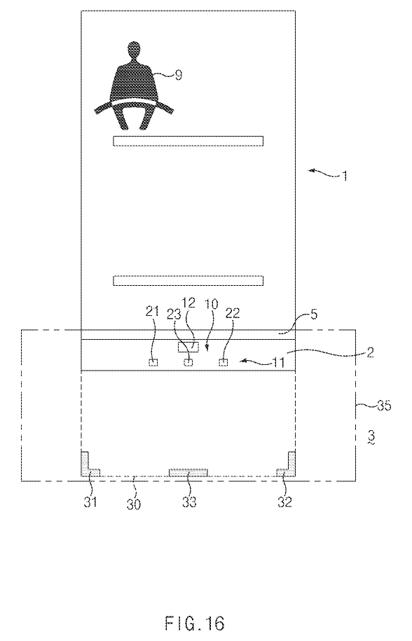

Referring to FIG. 16, if the vehicle 1 is stopped, all of the plurality of images 31, 32, and 33 may be projected in the first color by the image light projection unit 11.

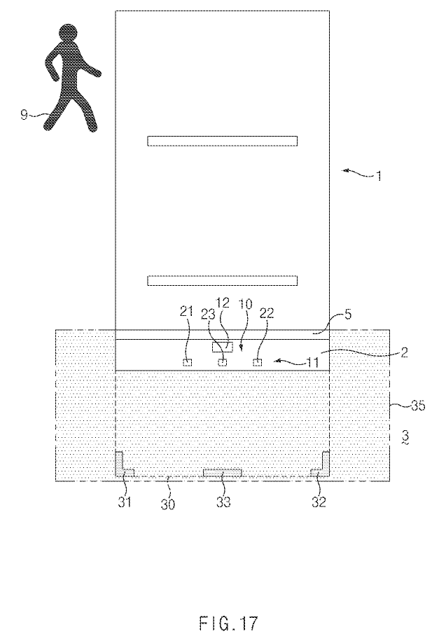

Referring to FIG. 17, in a state in which all of the plurality of images 31, 32, and 33 are illuminated in the first color, if an occupant 9 exits the vehicle 1, the illuminated region 35 may be projected in the first color by the diffused light projection unit 12.

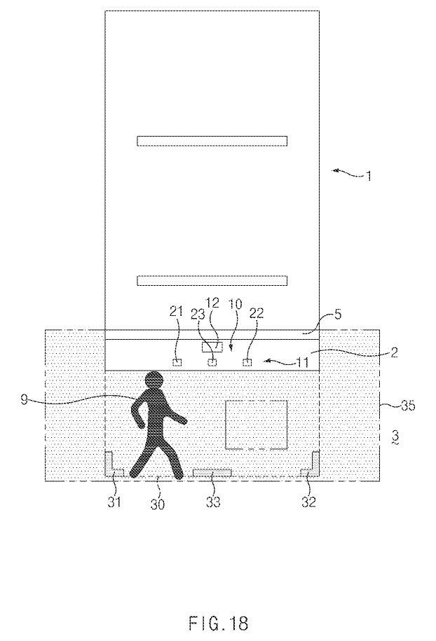

Referring to FIG. 18, if the occupant 9 is located near the rear of the vehicle 1, all of the plurality of images 31, 32, and 33 may be projected in the first color by the image light projection unit 11, and the illuminated region 35 may be projected in the first color by the diffused light projection unit 12.

If it is detected by the exterior camera 14a that the occupant is outside of a predetermined range (for example, a radius of 5m) from the vehicle 1, the plurality of images 31, 32, and 33 and the illuminated region 35 may be automatically turned off. Alternatively, the occupant may manually turn off the plurality of images 31, 32, and 33 and the illuminated region 35 using a smart key and a cellphone.

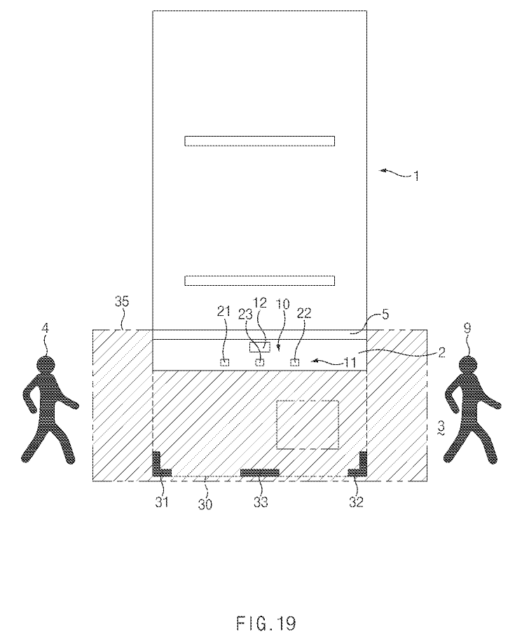

Referring to FIG. 19, if it is detected by the exterior camera 14a that the occupant 9 is located away from the rear of the vehicle 1 in a state in which the backdoor 5 is opened, or that a suspicious person 4 is approaching the rear of the vehicle 1, all of the plurality of images 31, 32, and 33 may be projected and blinked (i.e., each image light repeatedly turns on and off at regular intervals) in the second color by the image light projection unit 11, and the illuminated region 35 may be projected and blinked (i.e., the illuminated region repeatedly turns on and off at regular intervals) in the second color by the diffused light projection unit 12.

If the backdoor 5 is closed or if the suspicious person is located away from the rear of the vehicle 1, the plurality of images 31, 32, and 33 and the illuminated region 35 may be turned off.

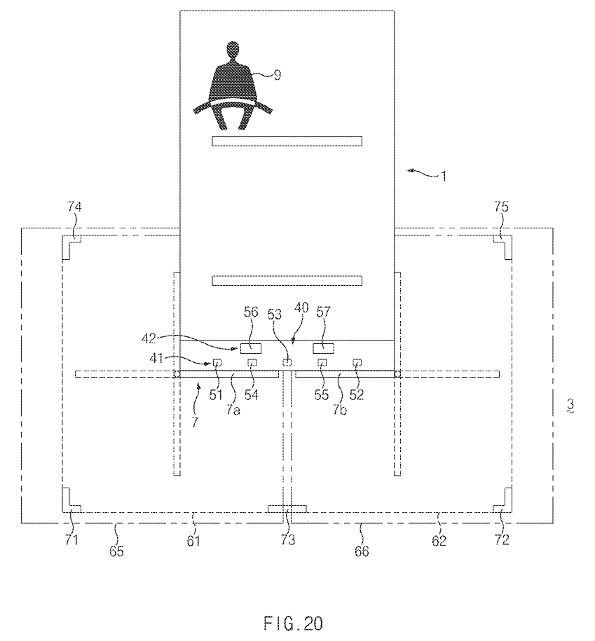

FIGS. 20 to 27 illustrate a control operation of the vehicle rear lighting system 40 illustrated in FIGS. 6 and 7.

Referring to FIG. 20, the controller 13 may check the specifications (dimensions, structure, size, shape, etc.) of the backdoor 7 by the backdoor monitoring portion 14k, and confirm that the backdoor 7 is a twin door tailgate. The controller 13 may calculate the first and second movement paths 61 and 62 of the backdoor 7 based on the information of the backdoor 7, and determine the display positions of the plurality of images 71, 72, 73, 74, and 75 and the ranges of the first and second illuminated regions 65 and 66 based on the calculated first and second movement paths 61 and 62 of the backdoor 7.

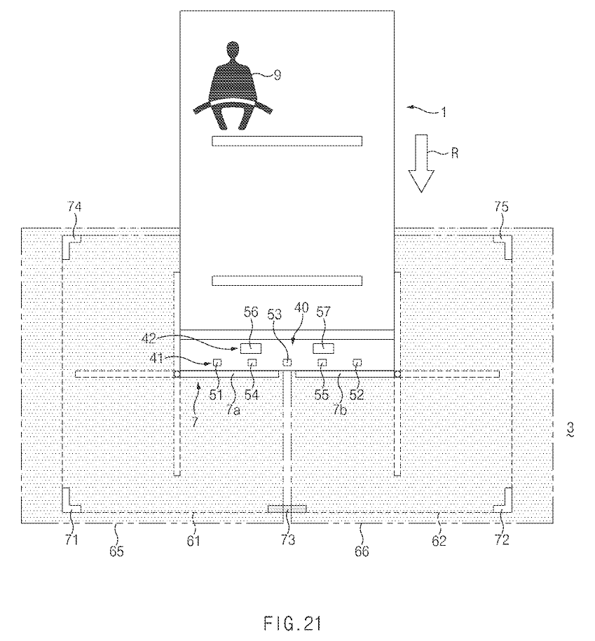

Referring to FIG. 21, if the vehicle 1 is moving backwards or reversing (see direction indicated by arrow R) for parking, the third image 73 among the plurality of images 71, 72, 73, 74, and 75 may be projected in the first color by the image light projection unit 41, and the first and second illuminated regions 65 and 66 may be projected in the first color by the diffused light projection unit 42.

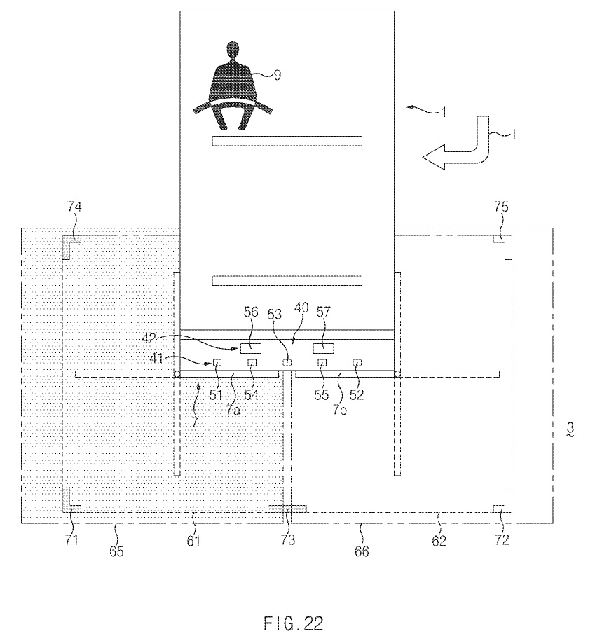

Referring to FIG. 22, as the vehicle 1 is moving backwards or reversing, some images 71, 73, and 74 among the plurality of images 71, 72, 73, 74, and 75 may be projected in the first color by the image light projection unit 41 to indicate the vehicle’s reverse direction. As shown in FIG. 22, if the vehicle 1 is moving backwards to the left (see direction indicated by arrow L), the first image 71, the third image 73, and the fourth image 74 may be projected in the first color, and the first illuminated region 65 may be projected in the first color. Although not shown, if the vehicle 1 is moving backwards to the right, the second image 72, the third image 73, and the fifth image 75 may be projected in the first color, and the second illuminated region 66 may be projected in the first color.

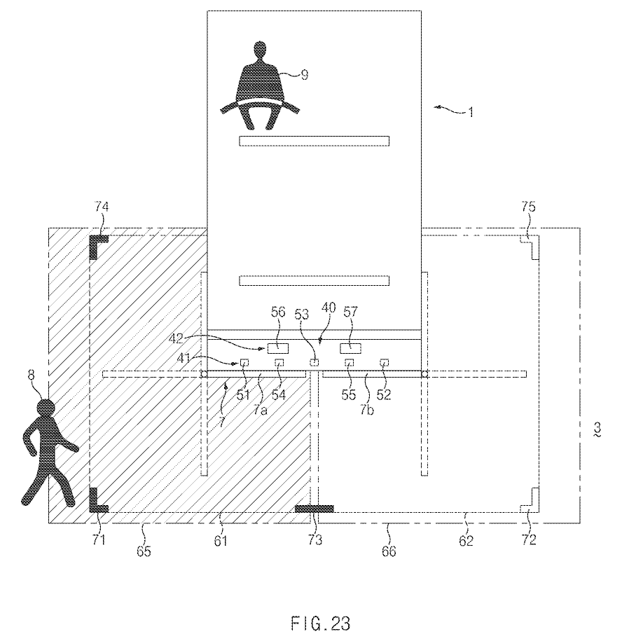

Referring to FIG. 23, if there is an object and/or a pedestrian 8 around the rear of the vehicle 1, some images (for example, the first image 71, the third image 73, and the fourth image 74) may be projected in the second color by the image light projection unit 41, and the first illuminated region 65 may be projected in the second color by the diffused light projection unit 42.

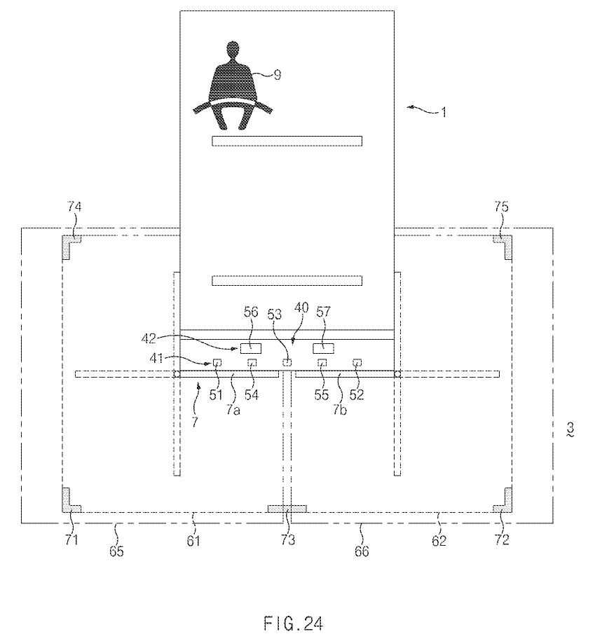

Referring to FIG. 24, if the vehicle 1 is stopped, all of the plurality of images 71, 72, 73, 74, and 75 may be projected in the first color by the image light projection unit 41.

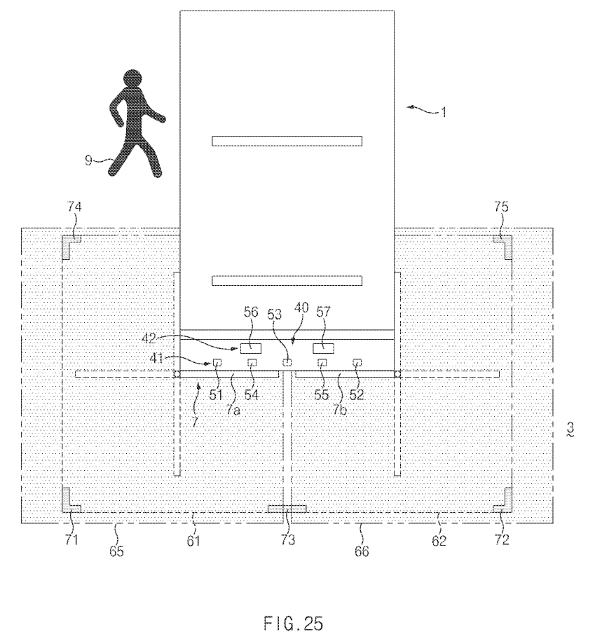

Referring to FIG. 25, in a state in which all of the plurality of images 71, 72, 73, 74, and 75 are projected in the first color, if an occupant 9 exits the vehicle 1, the first and second illuminated regions 65 and 66 may be projected in the first color by the diffused light projection unit 42.

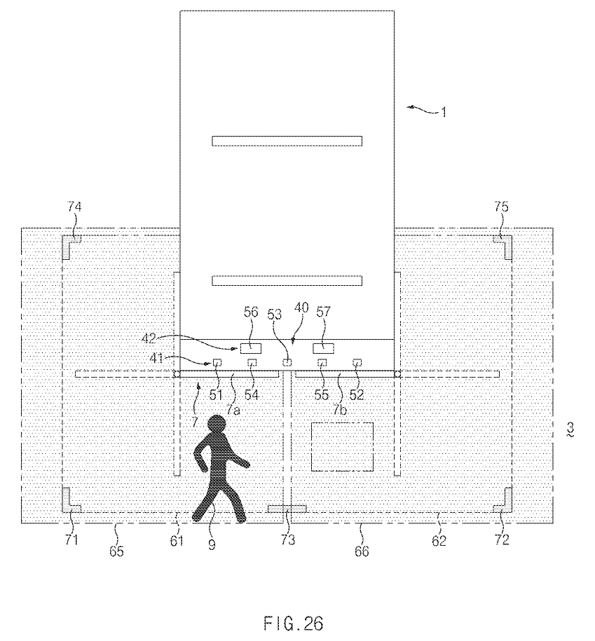

Referring to FIG. 26, if the occupant 9 is located near the rear of the vehicle 1, all of the plurality of images 71, 72, 73, 74, and 75 may be projected in the first color by the image light projection unit 41, and the first and second illuminated regions 65 and 66 may be projected in the first color by the diffused light projection unit 42.

Then, if it is detected by the exterior camera 14a that the occupant is outside of a predetermined range (for example, a radius of 5m) from the vehicle 1, the plurality of images 71, 72, 73, 74, and 75 and the first and second illuminated regions 65 and 66 may be automatically turned off. Alternatively, the occupant may manually turn off the plurality of images 71, 72, 73, 74, and 75 and the first and second illuminated regions 65 and 66 using a smart key and a cellphone.

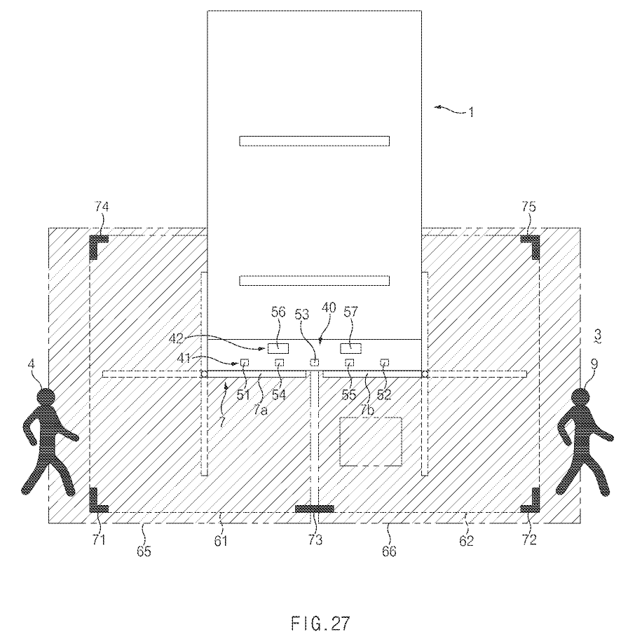

Referring to FIG. 27, if it is detected by the exterior camera 14a that the backdoor 7 is opened, or that a suspicious person 4 is located near the rear of the vehicle 1, all of the plurality of images 71, 72, 73, 74, and 75 may be projected and blinked (i.e., each image light repeatedly turns on and off at regular intervals) in the second color by the image light projection unit 41, and the first and second illuminated regions 65 and 66 may be projected and blinked (i.e., each illuminated region repeatedly turns on and off at regular intervals) in the second color by the diffused light projection unit 42.

If the backdoor 7 is closed or the suspicious person is located away from the rear of the vehicle 1, the plurality of images 71, 72, 73, 74, and 75 and the first and second illuminated regions 65 and 66 may be turned off.

As set forth above, the vehicle rear lighting system may be configured to allow at least one of the plurality of images (image light) and the illuminated region(s) to be projected in various colors on the ground by controlling the operations of the image light projection unit and the diffused light projection unit in a manner that allows at least one of the plurality of light patterns and the diffused light pattern(s) to be projected onto the ground based on the following information: the movement path of the backdoor, whether the vehicle is reversing, the vehicle’s reverse direction, whether the vehicle is stopped, whether an occupant exits the vehicle, whether there is an object (obstacles, other vehicles, etc.) and/or a pedestrian near the rear of the vehicle, whether the backdoor is opened, whether a suspicious person is approaching, and the like. Thus, the vehicle rear lighting system may optically display the vehicle information and the backdoor information if the vehicle is stopped and parked at night.

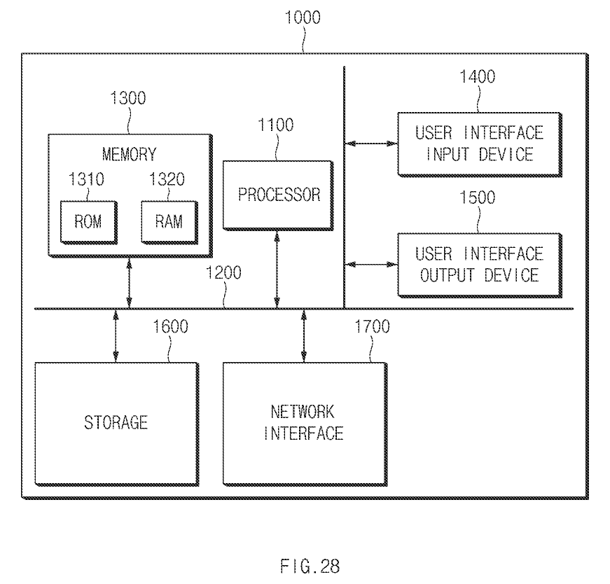

FIG. 28 shows an example computing system (e.g., a computing device of a vehicle or any other apparatus). One or more controllers, processors, etc. described herein may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communication channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an aspect of the present disclosure, a vehicle rear lighting system disposed on the rear of a vehicle adjacent to a backdoor of the vehicle may include: an image light projection unit projecting a plurality of light patterns onto the ground adjacent to the backdoor to display a plurality of images, respectively; a diffused light projection unit projecting a diffused light pattern onto the ground adjacent to the backdoor to define an illuminated region; and a controller controlling the image light projection unit and the diffused light projection unit based on information of the vehicle and information of the backdoor obtained from a vehicle information system.

According to the present disclosure, a vehicle rear lighting system disposed on the rear of a vehicle adjacent to a backdoor of the vehicle may include: an image light projection unit projecting a plurality of light patterns onto the ground adjacent to the backdoor to display a plurality of images, respectively; a diffused light projection unit projecting a diffused light pattern onto the ground adjacent to the backdoor to define an illuminated region; and a controller controlling the image light projection unit and the diffused light projection unit based on information of the vehicle and information of the backdoor obtained from a vehicle information system.

The plurality of images may define at least a portion of a movement path of the backdoor, and the illuminated region may include the movement path of the backdoor.

The controller may be configured to calculate the movement path of the backdoor based on the specifications of the backdoor, and to determine display positions of the plurality of images and a range of the illuminated region based on the calculated movement path of the backdoor.

The image light projection unit and the diffused light projection unit may be disposed on the rear of the vehicle.

The image light projection unit may include a plurality of image light projectors projecting the plurality of light patterns onto the ground, respectively.

Each image light projector may include a light source, and an optical system projecting light emitted from the light source onto the ground. The optical system may include a mask having patterned openings to determine the light patterns, and a plurality of lenses disposed behind the mask.

The diffused light projection unit may include a light source, and a diffuser allowing light emitted from the light source to spread out to the ground.

The vehicle information system may include a plurality of sensors sensing the information of the vehicle, and a backdoor monitoring portion monitoring the information of the backdoor.

According to another aspect of the present disclosure, a method of controlling a vehicle rear lighting system disposed on the rear of a vehicle adjacent to a backdoor of the vehicle and including an image light projection unit projecting a plurality of light patterns onto the ground adjacent to the backdoor to display a plurality of images defining at least a portion of a movement path of the backdoor, and a diffused light projection unit projecting a diffused light pattern onto the ground adjacent to the backdoor to define an illuminated region including the movement path of the backdoor may include: calculating the movement path of the backdoor based on the specifications of the backdoor, and determining display positions of the plurality of images and a range of the illuminated region based on the calculated movement path of the backdoor; and projecting at least one of the plurality of images indicating the reversing of the vehicle in a first color, and projecting the illuminated region in the first color in a state in which the vehicle is reversing after a vehicle speed has been reduced.

The method may further include projecting at least one of the plurality of images indicating a vehicle’s reverse direction in the first color, and projecting the illuminated region in the first color in a state in which an angle of a steering wheel is changed.

The method may further include projecting at least one of the plurality of images indicating a vehicle’s reverse direction in a second color, and projecting the illuminated region in the second color in a condition in which there is an object and/or a pedestrian around the rear of the vehicle.

The method may further include projecting the plurality of images in the first color in a state in which the vehicle is stopped.

The method may further include projecting the illuminated region in the first color in a condition in which an occupant has exited the vehicle.

The method may further include projecting and blinking the plurality of images and the illuminated region in a second color in a condition in which the occupant is located near or away from the rear of the vehicle with the backdoor opened.

The method may further include projecting and blinking the plurality of images and the illuminated region in the second color in a condition in which a suspicious person is approaching the rear of the vehicle.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle rear lighting system of a vehicle, the vehicle rear lighting system comprising:
one or more image projectors configured to project one or more light patterns onto a ground around a rear gate of the vehicle;
a diffused light projector configured to emit a diffused light pattern onto an illumination region of the ground around the rear gate; and
a control circuit configured to control, based on signals received from one or more sensors of the vehicle, the one or more image projectors and the diffused light projector.

2. The vehicle rear lighting system according to claim 1, wherein the one or more light patterns indicate at least a portion of a movement path of the rear gate, and
wherein the illumination region overlaps with the movement path of the rear gate.

3. The vehicle rear lighting system according to claim 2, wherein the control circuit is further configured to:
determine, based on dimensions of the rear gate, the movement path of the rear gate; and
determine, based on the movement path of the rear gate, a position of the one or more light patterns and a size of the illumination region.

4. The vehicle rear lighting system according to claim 1, wherein the one or more image projectors and the diffused light projector are disposed at a rear portion of the vehicle.

5. The vehicle rear lighting system according to claim 1, wherein each of the one or more image projectors comprises a gobo projector configured to project a respective light pattern, of the one or more light patterns, onto the ground around the rear gate of the vehicle.

6. The vehicle rear lighting system according to claim 5, wherein the gobo projector comprises:
a light source configured to emit light; and
an optical system configured to project the light emitted from the light source onto the ground around the rear gate, and
wherein the optical system comprises:
a mask having one or more patterned openings corresponding to the one or more light patterns; and
one or more lenses disposed behind the mask.

7. The vehicle rear lighting system according to claim 1, wherein the diffused light projector comprises:
a light source configured to emit light; and
a diffuser configured to diffuse the light emitted from the light source onto the ground around the rear gate.

8. The vehicle rear lighting system according to claim 1, wherein the one or more sensors are configured to:
collect information about the vehicle; and
generate, based on the information about the vehicle, the signals, and
wherein the control circuit is configured to control the one or more image projectors and the diffused light projector further based on information about the rear gate.

9. A method performed by an apparatus of a vehicle, the method comprising:
determining, based on dimensions of a rear gate of the vehicle, a movement path of the rear gate;
determining, based on the movement path of the rear gate, a position of one or more light patterns and a size of an illumination region; and
based on a speed of the vehicle being decreased and the vehicle performing a reversing operation:
projecting, in a first color via one or more image projectors of the vehicle, at least one light pattern, of the one or more light patterns, that indicates the reversing operation of the vehicle; and
projecting, in the first color via a diffused light projector of the vehicle, diffused light onto the illumination region.

10. The method according to claim 9, further comprising, based on an angle change of a steering wheel of the vehicle:
projecting, in the first color via the one or more image projectors, at least one light pattern, of the one or more light patterns, that indicates a reversing direction of the vehicle; and
projecting, in the first color via the diffused light projector, the diffused light onto the illumination region.

11. The method according to claim 9, further comprising, based on detecting an object or a pedestrian around a rear of the vehicle:
projecting, in a second color via the one or more image projectors, at least one light pattern, of the one or more light patterns, that indicates a reversing direction of the vehicle; and
projecting, in the second color via the diffused light projector, the diffused light onto the illumination region.

12. The method according to claim 9, further comprising, based on the vehicle being stopped, projecting, in the first color via the one or more image projectors, the one or more light patterns.

13. The method according to claim 9, further comprising, based on a vehicle occupant exiting the vehicle, projecting, in the first color via the diffused light projector, the diffused light onto the illumination region.

14. The method according to claim 9, further comprising, based on detecting a vehicle occupant being within a threshold distance from a rear of the vehicle:
projecting and blinking, in a second color via the one or more image projectors, the one or more light patterns; and
projecting and blinking, in the second color via the diffused light projector, the illumination region.

15. The method according to claim 9, further comprising, based on detecting a person approaching a rear of the vehicle:
projecting and blinking, in a second color via the one or more image projectors, the one or more light patterns; and
projecting and blinking, in the second color via the diffused light projector, the illumination region.

16. An apparatus for a vehicle, the apparatus comprising:
a projector configured to emit one or more light patterns on a ground surface; and
a control circuit configured to control, based on determining that a rear gate of the vehicle is open, the projector to emit the one or more light patterns on the ground surface, wherein the one or more light patterns indicate, on the ground surface, a clearance area of the rear gate.

17. The apparatus according to claim 16, wherein the projector comprises at least one of a gobo projector or a diffused light projector.

18. The apparatus according to claim 16, wherein the control circuit is further configured to control, based on determining that a person is approaching the vehicle, the projector to emit and blink the one or more light patterns on the ground surface.

19. The apparatus according to claim 16, wherein each of the one or more light patterns comprise a line segment indicating a border of the clearance area.
